(19) United States
(12) Patent Application Publication
(10) Pub. No.: US 2003/0009936 A1
(43) Pub. Date: Jan. 16, 2003

(54) Flexible plant protecting cover

(76) Inventor: Cheryl Ann Hodson, Sun City, CA (US)

Correspondence Address: Richard W. Goldstein, 2071 Clove Road, Staten Island, NY, 10304, US

(21) Appl. No.: 09/901,771

(22) Filed: Jul. 10, 2001

(51) Int. Cl. A47G 7/08; A01G 13/02

(52) U.S. Cl. 47/29.1

(57) ABSTRACT

A flexible plant protecting cover including a cover member adapted for enclosing a selected plant. The cover member has a waterproof outer layer and a cotton inner layer. The cover member has an upper edge, a lower edge, and opposed side edges. The upper edge is folded over to form an interior chamber having opposed open ends. The interior chamber has a pull string disposed therein. The pull string has opposed free ends extending outwardly of the opposed open ends of the interior chamber. The opposed side edges each have corresponding couplers. The cover member is wrapped around the selected plant with the opposed side edges engaged via the couplers. The opposed free ends of the pull string are pulled together and tied to form a significantly closed upper end around the selected plant.

### BACKGROUND OF THE INVENTION

The present invention relates to a flexible plant protecting cover and more particularly pertains to protecting plants from frost and inclement weather.

The use of horticultural devices is known in the prior art. More specifically, horticultural devices heretofore devised and utilized for the purpose of protecting plants and the like are known to consist basically of familiar, expected and obvious structural configurations, notwithstanding the myriad of designs encompassed by the crowded prior art which have been developed for the fulfillment of countless objectives and requirements.

By way of example, U.S. Pat. No. 5,375,368 to Motz, Jr. discloses a film that is rolled into a cylinder for surrounding a plant and providing protection from ultra-violet radiation. U.S. Pat. No. 6,014,837 to Morgan discloses a flexible shield supported by a pair of rods for protecting a plant from weather and animals. U.S. Pat. No. 4,763,440 to James discloses a sprinkler system used to protect plants from freezing.

While these devices fulfill their respective, particular objective and requirements, the aforementioned patents do not describe a flexible plant protecting cover for protecting plants from frost and inclement weather.

In this respect, the flexible plant protecting cover according to the present invention substantially departs from the conventional concepts and designs of the prior art, and in doing so provides an apparatus primarily developed for the purpose of protecting plants from frost and inclement weather.

Therefore, it can be appreciated that there exists a continuing need for a new and improved flexible plant protecting cover which can be used for protecting plants from frost and inclement weather. In this regard, the present invention substantially fulfills this need.

### SUMMARY OF THE INVENTION

In the view of the foregoing disadvantages inherent in the known types of horticultural devices now present in the prior art, the present invention provides an improved flexible plant protecting cover. As such, the general purpose of the present invention, which will be described subsequently in greater detail, is to provide a new and improved flexible plant protecting cover which has all the advantages of the prior art and none of the disadvantages.

To attain this, the present invention essentially comprises a cover member adapted for enclosing a selected plant. The cover member has a waterproof outer layer and a cotton inner layer. The cover member has an upper edge, a lower edge, and opposed side edges. The upper edge is folded over to form an interior chamber having opposed open ends. The interior chamber has a pull string disposed therein. The pull string has opposed free ends extending outwardly of the opposed open ends of the interior chamber. The opposed free ends each have a ball secured thereto. The opposed side edges each have corresponding pile type fasteners extending an entire length thereof. The cover member is wrapped around the selected plant with the opposed side edges engaged via the pile type fasteners. The opposed free ends of the pull string are pulled together and tied to form a significantly closed upper end around the selected plant.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

It is therefore an object of the present invention to provide a new and improved flexible plant protecting cover which has all the advantages of the prior art horticultural devices and none of the disadvantages.

It is another object of the present invention to provide a new and improved flexible plant protecting cover which may be easily and efficiently manufactured and marketed.

It is a further object of the present invention to provide a new and improved flexible plant protecting cover which is of durable and reliable construction.

An even further object of the present invention is to provide a new and improved flexible plant protecting cover which is susceptible of a low cost of manufacture with regard to both materials and labor, and which accordingly is then susceptible of low prices of sale to the consuming public, thereby making such a flexible plant protecting cover economically available to the buying public.

Even still another object of the present invention is to provide a new and improved flexible plant protecting cover for protecting plants from frost and inclement weather.

Lastly, it is an object of the present invention to provide a new and improved flexible plant protecting cover including a cover member adapted for enclosing a selected plant. The cover member has a waterproof outer layer and a cotton inner layer. The cover member has an upper edge, a lower edge, and opposed side edges. The upper edge is folded over to form an interior chamber having opposed open ends. The interior chamber has a pull string disposed therein. The pull string has opposed free ends extending outwardly of the opposed open ends of the interior chamber. The opposed side edges each have corresponding coupling means. The cover member is wrapped around the selected plant with the opposed side edges engaged via the coupling means. The opposed free ends of the pull string are pulled together and tied to form a significantly closed upper end around the selected plant.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the flexible plant protecting cover constructed in accordance with the principles of the present invention.

FIG. 2 is a cross-sectional side view of the present invention.

The same reference numerals refer to the same parts through the various figures.

### DESCRIPTION OF THE PREFERRED EMBODIMENT

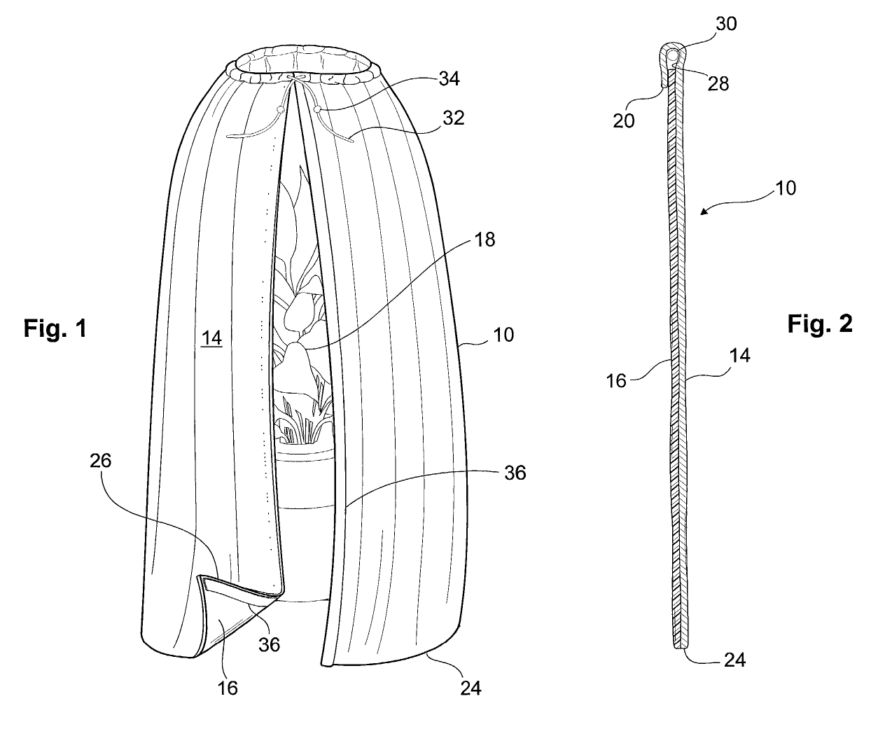

With reference now to the drawings, and in particular, to FIGS. 1 and 2 thereof, the preferred embodiment of the new and improved flexible plant protecting cover embodying the principles and concepts of the present invention and generally designated by the reference number 10 will be described.

Specifically, it will be noted in the various figures that the device relates to a flexible plant protecting cover for protecting plants from frost and inclement weather.

The present invention is essentially comprised of a cover member 10. The cover member 10 is adapted for enclosing a selected plant. The cover member has a waterproof outer layer 14 and a cotton inner layer 16. The waterproof outer layer, preferably of vinyl construction, will keep water and moisture off of a plant 18 during use. The cotton inner layer 16 will serve to provide warmth to the plant 18 during use. The cover member 10 has an upper edge 20, a lower edge 24, and opposed side edges 26. The upper edge 20 is folded over to form an interior chamber 28 having opposed open ends. The interior chamber 28 has a pull string 30 disposed therein. The pull string 30 has opposed free ends 32 extending outwardly of the opposed open ends of the interior chamber 28. The opposed free ends 32 each have a ball 34 secured thereto. The ball 34 will prevent the opposed free ends 32 from entering the interior chamber 28. The opposed side edges 26 each have corresponding pile type fasteners 36 extending an entire length thereof. The cover member 10 is wrapped around the selected plant 18 with the opposed side edges 26 engaged via the pile type fasteners 36. The opposed free ends 32 of the pull string 30 are pulled together and tied to form a significantly closed upper end around the selected plant 18. When the pull string 30 is tightened to form the significantly closed upper end, an opening remains to provide air circulation.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A flexible plant protecting cover for protecting plants from frost and inclement weather comprising, in combination:
a cover member adapted for enclosing a selected plant, the cover member having a waterproof outer layer and a cotton inner layer, the cover member having an upper edge, a lower edge, and opposed side edges, the upper edge being folded over to form an interior chamber having opposed open ends, the interior chamber having a pull string disposed therein, the pull string having opposed free ends extending outwardly of the opposed open ends of the interior chamber, the opposed free ends each having a ball secured thereto, the opposed side edges each having corresponding pile type fasteners extending an entire length thereof, the cover member being wrapped around the selected plant with the opposed side edges engaged via the pile type fasteners, the opposed free ends of the pull string being pulled together and tied to form a significantly closed upper end around the selected plant.

2. A flexible plant protecting cover for protecting plants from frost and inclement weather comprising, in combination:
a cover member adapted for enclosing a selected plant, the cover member having a waterproof outer layer and a cotton inner layer, the cover member having an upper edge, a lower edge, and opposed side edges, the upper edge being folded over to form an interior chamber having opposed open ends, the interior chamber having a pull string disposed therein, the pull string having opposed free ends extending outwardly of the opposed open ends of the interior chamber, the opposed side edges each having corresponding coupling means, the cover member being wrapped around the selected plant with the opposed side edges engaged via the coupling means, the opposed free ends of the pull string being pulled together and tied to form a significantly closed upper end around the selected plant.

3. The flexible plant protecting cover as set forth in claim 2, wherein the opposed free ends of the pull string each have a ball secured thereto.
